(19) United States
(12) Patent Application Publication
(10) Pub. No.: US 2021/0310523 A1
(43) Pub. Date: Oct. 7, 2021

(54) CLUTCH DEVICE

(71) Applicant: EXEDY Corporation, Osaka (JP)

(72) Inventor: Noriko MATSUYOSHI, Osaka (JP)

(73) Assignee: Exedy Corporation

(21) Appl. No.: 17/193,810

(22) Filed: Mar. 5, 2021

(30) Foreign Application Priority Data
Apr. 1, 2020 (JP) 2020-065997

(51) Int. Cl. F16D 13/64; F16D 13/74; F16D 13/70

(52) U.S. Cl. CPC F16D 13/646; F16D 13/648; F16D 13/70; F16D 13/74

(57) ABSTRACT

A clutch device includes a first rotor, a second rotor, and a clutch plate. The first rotor includes a first slide surface. The second rotor includes a second slide surface disposed axially apart from the first slide surface. The second rotor is axially movable relative to the first rotor. The clutch plate is disposed between the first slide surface and the second slide surface. The first rotor includes an opposite surface that is axially opposite to the first slide surface. The opposite surface includes a plurality of recesses, a ribbed portion, and a coupling portion. The recesses are circumferentially aligned. The ribbed portion radially extends between each adjacent pair of the recesses. The coupling portion is disposed radially outside the recesses and circumferentially extends such that each adjacent pair of ribs in the ribbed portion is coupled therethrough.

### CROSS-REFERENCE TO RELATED APPLICATIONS

This application claims priority to Japanese Patent Application No. 2020-065997, filed on Apr. 1, 2020. The contents of that application are incorporated by reference herein in their entirety.

### TECHNICAL FIELD

The present invention relates to a clutch device.

### BACKGROUND ART

In general, motorcycles (a two-wheeled motorcycle, a buggy, etc.) use a clutch device so as to allow or block transmitting power from an engine to a transmission. The clutch device includes a clutch outer, a first rotor, a clutch plate, and a second rotor. The clutch outer is coupled to an engine crankshaft side. The first rotor is coupled to a transmission side. The clutch plate is disposed between the clutch outer and the first rotor so as to allow or block transmission of power. The second rotor is provided for pressing the clutch plate.

A clutch device described in Japan Laid-open Patent Application Publication No. 2009-79706 has been proposed as this type of clutch device. In the clutch device, for a lightweight configuration, the first rotor is provided with recesses in an annular portion located on a radially outer side and a portion ranging from the annular portion to a rotational shaft.

However, in the clutch device described in Japan Laid-open Patent Application Publication No. 2009-79706, the first rotor is provided with the recesses in both the annular outer peripheral portion and the portion ranging from the annular outer peripheral portion to the shaft. Because of this, the first rotor is degraded in strength.

### BRIEF SUMMARY

It is an object of the present invention to make a constituent member of a clutch device lightweight without degrading strength of the constituent member.

(1) A clutch device according to an aspect of the present invention includes a first rotor including a first slide surface, a second rotor, and a clutch plate. The second rotor includes a second slide surface disposed axially apart from the first slide surface. The second rotor is axially movable relative to the first rotor. The clutch plate is disposed between the first slide surface and the second slide surface. The first rotor includes an opposite surface axially opposite to the first slide surface. The opposite surface includes a plurality of recesses, a ribbed portion, and a coupling portion. The plurality of recesses are circumferentially aligned. The ribbed portion radially extend between each adjacent pair of the plurality of recesses. The coupling portion is disposed radially outside the plurality of recesses. The coupling portion circumferentially extends such that each adjacent pair of ribs in the ribbed portion is coupled therethrough.

In the present device, the first rotor includes the plural recesses, the ribbed portion, and the coupling portion. The first rotor is reinforced by the coupling portion. Hence, the first rotor can be made lightweight by enlarging the recesses without being degraded in strength.

(2) Each of the plurality of recesses includes a bottom surface portion and a lateral surface portion. The lateral surface portion is greater in height at a radially inner part thereof than at a radially outer part thereof.

(3) The ribbed portion reduces in height from radially inside to radially outside.

(4) Each of the ribs in the ribbed portion includes a surface parallel to the second slide surface and a surface reducing in height from radially inside to radially outside.

When each rib in the ribbed portion includes the surface parallel to the second slide surface and the surface reducing in height from radially inside to radially outside, the first rotor can be further enhanced in strength.

(5) The first rotor includes an annular region circumferentially extending on the opposite surface axially opposite to the first slide surface. The annular region includes a first region and a second region. The first region is provided with the plurality of recesses. The second region is not provided with the plurality of recesses.

(6) Preferably, the first rotor includes a plurality of oil pathways. The oil pathways penetrate the first rotor in a thickness direction of the first rotor and are circumferentially aligned. The second region is disposed radially outside each of the plurality of oil pathways at an interval.

The first rotor herein includes the oil pathways. Because of this, lubricating oil is supplied through the oil pathways to the surface of the clutch plate and an engaging part between the clutch plate and the first rotor.

Furthermore, the second region, not provided with the recesses, are herein disposed radially outside each of the oil pathways at an interval. In other words, the recesses are not provided in the vicinity of the oil pathways. Hence, the first rotor is not herein degraded in strength.

(7) Preferably, the first rotor is a clutch center. Besides, the second rotor is a pressure plate.

Overall, according to the present invention described above, a constituent member of a clutch device can be made lightweight without being degraded in strength.

### BRIEF DESCRIPTION OF THE DRAWINGS

FIG. 1 is a cross-sectional view of a clutch device according to an embodiment of the present invention.

FIG. 2 is an external perspective view of a clutch center as seen from a first side in an axial direction.

FIG. 3 is an external perspective view of the clutch center as seen from a second side in the axial direction.

FIG. 4 is a cross-sectional view of the clutch center.

FIG. 5 is an external perspective view of a pressure plate as seen from the first side in the axial direction.

FIG. 6 is an external perspective view of the pressure plate as seen from the second side in the axial direction.

FIG. 7 is an external perspective view of a support plate.

FIG. 8 is a planar net for explaining cam mechanisms.

FIG. 9 is an external perspective view of the pressure plate as seen from the first side in the axial direction.

FIG. 10 is a cross-sectional view of the pressure plate.

FIG. 11 is a cross-sectional view of a push-type clutch device according to another embodiment.

### DETAILED DESCRIPTION

### Entire Configuration

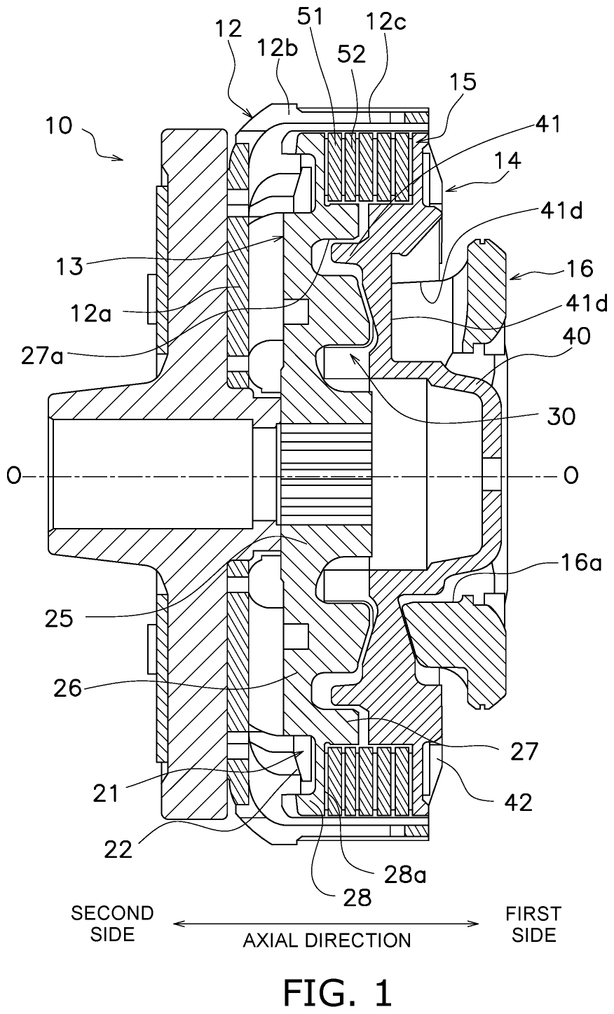

FIG. 1 shows a clutch device 10 for a motorcycle as a clutch device according to an embodiment of the present invention. In a cross-sectional view of FIG. 1, line 0-0 indicates a rotational axis. It should be noted that in the following explanation, the term “axial direction” indicates an extending direction of a rotational axis 0. As shown in FIG. 1, the right side in FIG. 1 is defined as “a first side in the axial direction”, whereas the left side in FIG. 1 is defined as “a second side in the axial direction”. Besides, the term “radial direction” means a radial direction of an imaginary circle about the rotational axis 0. Moreover, the term “circumferential direction” means a circumferential direction of the imaginary circle about the rotational axis 0.

The clutch device 10 is configured to allow or block transmitting power from an engine to a transmission. The clutch device 10 includes a clutch outer 12, a clutch center 13 (exemplary first rotor), a pressure plate 14 (exemplary second rotor), a clutch plate 15, and a support plate 16. Besides, the clutch device 10 further includes a plurality of coil springs 19 for applying pressure.

### Clutch Outer 12

The clutch outer 12 includes a disc portion 12a and a tubular portion 12b and is coupled to an input gear. The input gear is meshed with a drive gear (not shown in the drawings) fixed to an engine-side crankshaft.

The input gear is coupled to the disc portion 12a through a plurality of coil springs (not shown in the drawings). The plural coil springs are provided for absorbing vibration from the engine and are inserted into holes provided in the input gear.

The tubular portion 12b is provided to extend from the outer peripheral edge of the disc portion 12a to the first side in the axial direction. The tubular portion 12b is provided with a plurality of cutouts 12c extending in the axial direction. The plural cutouts 12c are aligned at predetermined intervals in the circumferential direction.

### Clutch Center 13

With reference to FIGS. 1 to 3, the clutch center 13 is disposed in the interior of the clutch outer 12, in other words, radially inside the tubular portion 12b of the clutch outer 12. The clutch center 13 has an approximately disc shape. The clutch center 13 includes a boss portion 25 provided on the middle part thereof, a disc portion 26, a tubular portion 27, a pressure receiving portion 28, and oil pathways 45.

The boss portion 25 extends in the axial direction. The boss portion 25 is provided with a spline hole (not shown in the drawings) in the middle part thereof. The spline hole extends in the axial direction. An input shaft of the transmission (not shown in the drawings) is engaged with the spline hole. It should be noted that the clutch center 13 is not moved in the axial direction.

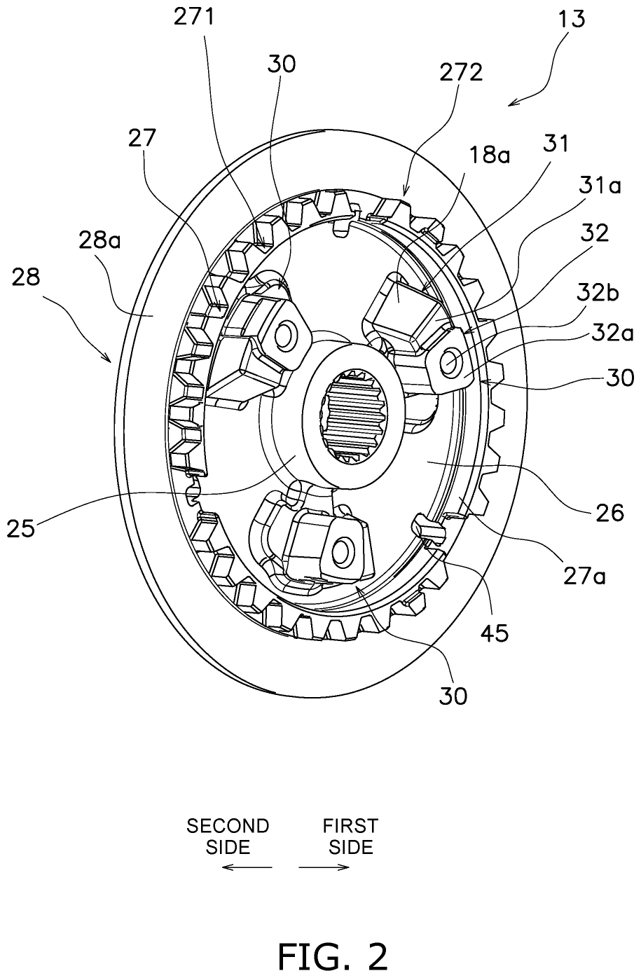

The disc portion 26 extends radially outward from the boss portion 25. As shown in FIGS. 1 and 2, the disc portion 26 is provided with a plurality of first protruding portions 30. It should be noted that in the present embodiment, the disc portion 26 includes three first protruding portions 30. The plural first protruding portions 30 are provided on a radially intermediate part of the disc portion 26, while being disposed at intervals in the circumferential direction. The first protruding portions 30 protrude to the first side in the axial direction. Besides, the plural first protruding portions 30 are disposed apart from an inner peripheral surface 27a of the tubular portion 27. A gap is reliably produced between the outer peripheral surface of each first protruding portion 30 and the inner peripheral surface 27a of the tubular portion 27.

With reference to FIG. 2, each first protruding portion 30 includes a first cam protrusion 31 and a first fixation protrusion 32. The first cam protrusion 31 and the first fixation protrusion 32 are aligned in the circumferential direction. The first cam protrusion 31 and the first fixation protrusion 32 are provided as a single member.

The first cam protrusion 31 includes a CC cam surface 18a.

The first fixation protrusion 32 is greater in height than the first cam protrusion 31. In other words, a distal end surface 32a (axially first side end surface) of the first fixation protrusion 32 is located on the first side of a distal end surface 31a of the first cam protrusion 31 in the axial direction. It should be noted that the height of the first fixation protrusion 32 indicates the length thereof in the axial direction.

Besides, the first fixation protrusion 32 is provided with a screw hole 32b in the center part thereof. The screw hole 32b extends in the axial direction.

The tubular portion 27 is provided to extend from an outer part of the disc portion 26 to the first side in the axial direction. The tubular portion 27 includes a body 271 having a cylindrical shape and a plurality of first teeth 272 provided for an engagement purpose on the outer peripheral surface of the body 271.

The pressure receiving portion 28 is provided on the outer peripheral side of the tubular portion 27 and further extends therefrom to the outer peripheral side. The pressure receiving portion 28 has an annular shape and includes a first slide surface 28a facing the first side in the axial direction.

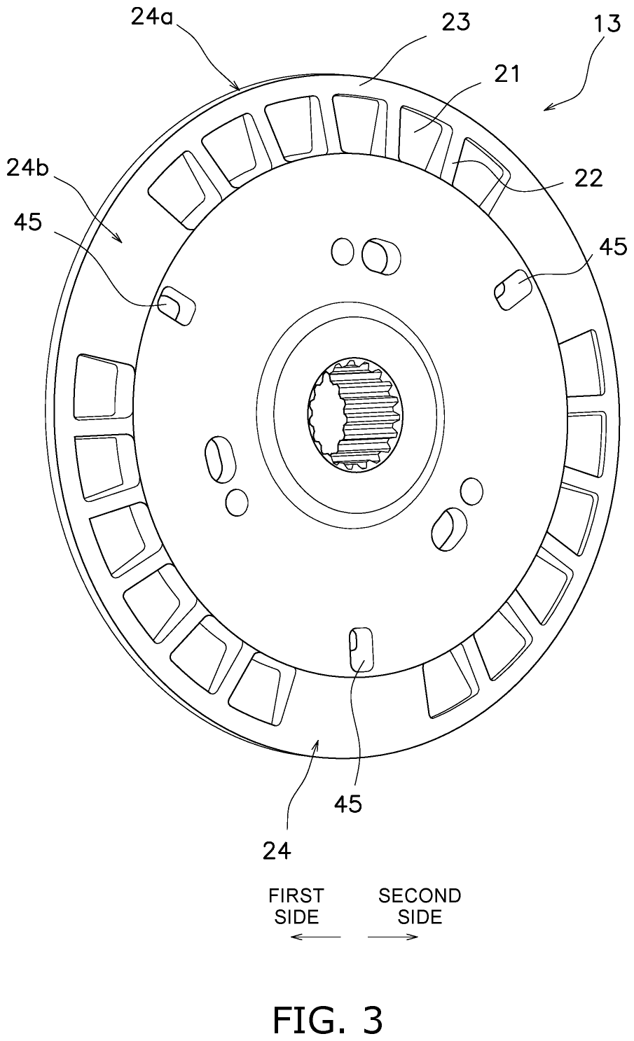

With reference to FIG. 3, an annular region 24 exists on the axially second side surface of the pressure receiving portion 28. The annular region 24 is a surface axially opposite to the first slide surface 28a. The annular region 24 circumferentially extends in an annular shape. The annular region 24 includes first regions 24a and second regions 24b. Each first region 24a is provided with a plurality of recesses 21. Each second region 24b is not provided with any recesses 21. Each second region 24b is greater in circumferential length than each recess 21. For example, each second region 24b is circumferentially twice to three times as long as each recess 21.

Each first region 24a includes the plural recesses 21, a ribbed portion 22, and a coupling portion 23.

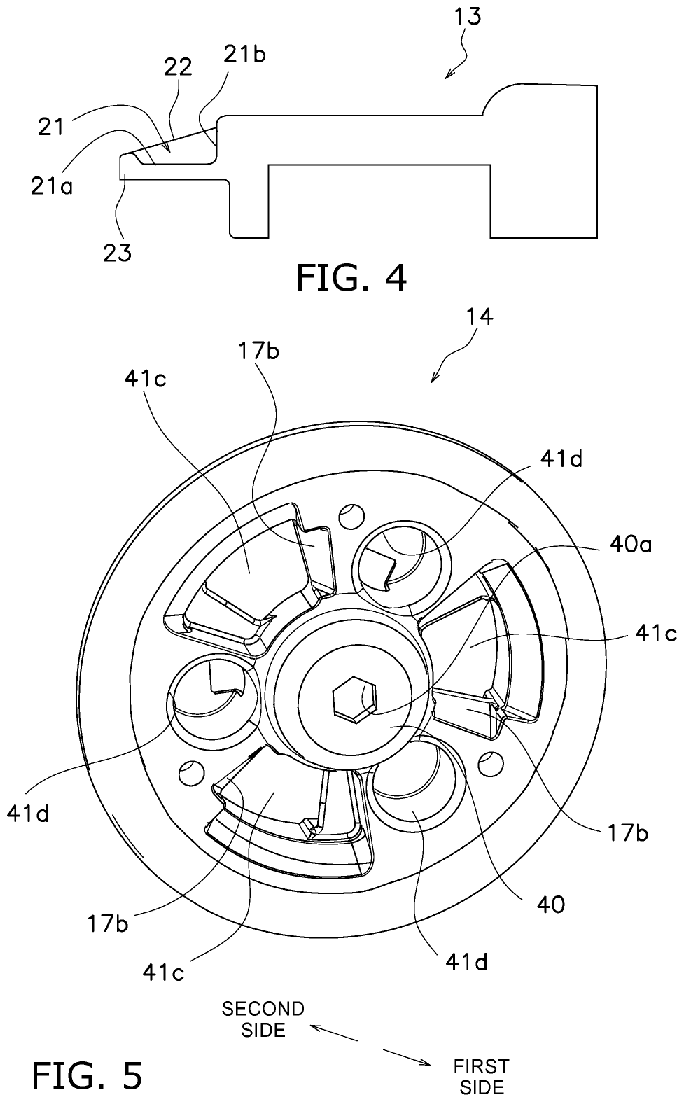

The plural recesses 21 are aligned in the circumferential direction. As shown in FIG. 4, each recess 21 includes a bottom surface portion 21a and a lateral surface portion 21b. The bottom surface portion 21a includes a surface parallel to the first slide surface 28a. The lateral surface portion 21b is greater in height at a radially inner part thereof than at a radially outer part thereof.

The ribbed portion 22 radially extends between each adjacent pair of recesses 21. The ribbed portion 22 reduces in height from radially inside to radially outside.

The coupling portion 23 is disposed radially outside the recesses 21. The coupling portion 23 circumferentially extends such that each adjacent pair of ribs in the ribbed portion 22 is coupled therethrough.

As shown in FIGS. 2 and 3, the clutch center 13 is provided with the plural oil pathways 45. The oil pathways 45 are disposed in the circumferential directions, while penetrating the clutch center 13 in the thickness direction thereof. The oil pathways 45 are configured to supply lubricating oil, residing on the inner peripheral side of the tubular portion 27, to the clutch plate 15 disposed on the outer peripheral side of the tubular portion 27.

The body 271 and the first teeth 272 are not provided at sites provided with the oil pathways 45.

With the oil pathways 45 described above, during actuation, the lubricating oil, residing on the inner peripheral side of the tubular portion 27, is supplied therethrough to the clutch plate 15 disposed on the outer peripheral side of the tubular portion 27.

The second regions 24b are disposed radially outside the oil pathways 45 at intervals, respectively.

### Pressure Plate 14

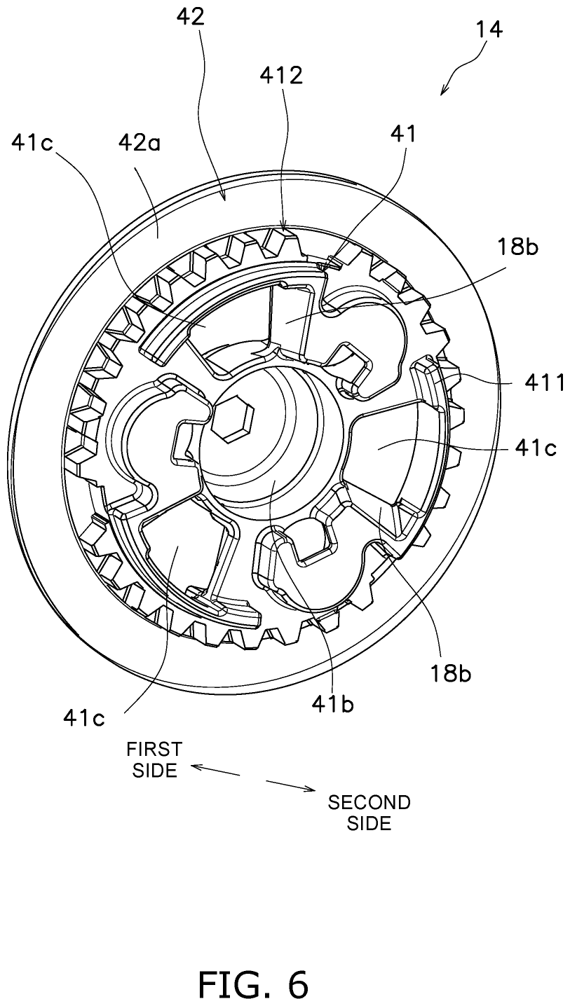

As shown in FIGS. 1, 5, and 6, the pressure plate 14 is a disc-shaped member. The pressure plate 14 is disposed on the first side of the clutch center 13 in the axial direction.

The pressure plate 14 is axially movable with respect to the clutch center 13. The pressure plate 14 includes a boss portion 40 provided on the middle part thereof, a tubular portion 41, and a pressure applying portion 42.

The boss portion 40 extends to protrude to the first side in the axial direction. The boss portion 40 defines a through hole 40a by the radially inner peripheral wall thereof. A release member (not shown in the drawings) is inserted into the through hole 40a.

The tubular portion 41 is provided radially outside the boss portion 40. The tubular portion 41 protrudes to the second side in the axial direction. The tubular portion 41 is disposed to overlap the tubular portion 27 of the clutch center 13 as seen in a radial view. Besides, the tubular portion 41 is disposed to be inserted into gaps produced between the tubular portion 27 and the first protruding portions 30 in the clutch center 13.

The tubular portion 41 includes a body 411 having a cylindrical shape and a plurality of second teeth 412. The second teeth 412 are provided on the outer peripheral surface of the body 411. The plural second teeth 412 are provided on the axially first side end on the outer peripheral surface of the body 411. The plural second teeth 412 are less in axial length than the body 411. Besides, the oil pathways 45 are opened to the first side in the axial direction. Hence, the lubricating oil is led to the second teeth 412 of the pressure plate 14 as well.

Besides, the tubular portion 41 includes a hole 41b, which has an approximately circular shape and is provided in the middle part thereof, a plurality of cam holes 41c, and a plurality of closed-end holes 41d. It should be noted that in the present embodiment, the tubular portion 41 includes three cam holes 41c and three closed-end holes 41d.

The pressure plate 14 includes PPa cam surfaces 17b for an assist cam mechanism 17 and PPs cam surfaces 18b for a slipper cam mechanism 18. Each PPa cam surface 17b and each PPs cam surface 18b are composed of inner wall surfaces defining each cam hole 41c. Each PPa cam surface 17b and each PPs cam surface 18b are opposed in the circumferential direction. Each PPa cam surface 17b faces the first side in the axial direction. Each PPs cam surface 18b faces the second side in the axial direction.

The closed-end holes 41d are each provided to be recessed at a predetermined depth from the axially first side surface of the tubular portion 41. The coil springs 19 are disposed in the closed-end holes 41d shown in FIG. 1, respectively.

The pressure applying portion 42 has an annular shape and is provided as the outer peripheral part of the pressure plate 14. The pressure applying portion 42 includes a second slide surface 42a facing the second side in the axial direction. The pressure applying portion 42 is disposed axially apart from the pressure receiving portion 28 at an interval.

### Support Plate 16

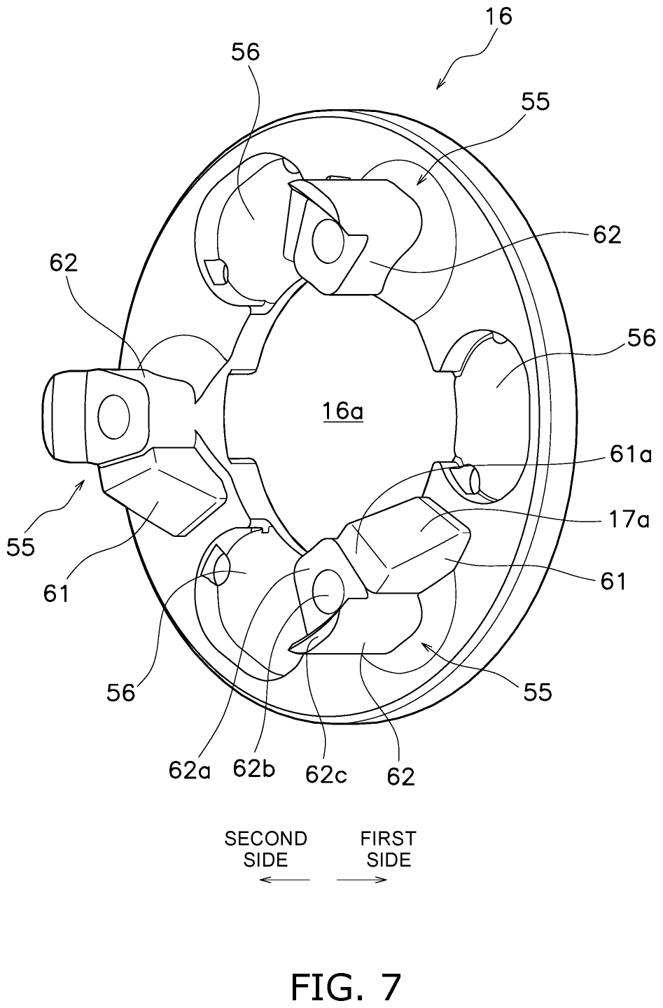

As shown in FIGS. 1 and 7, the support plate 16 is a disc-shaped member and is disposed on the first side of the pressure plate 14 in the axial direction. The support plate 16 includes a hole 16a in the middle part thereof. The hole 16a is penetrated by the boss portion 40 of the pressure plate 14.

Besides, the support plate 16 includes a plurality of second protruding portions 55 and a plurality of recesses 56. It should be noted that in the present embodiment, the support plate 16 includes three second protruding portions 55 and three recesses 56.

The plural second protruding portions 55 are disposed at intervals in the circumferential direction. Preferably, the plural second protruding portions 55 are disposed at equal intervals in the circumferential direction. The second protruding portions 55 protrude to the second side in the axial direction. Each second protruding portion 55 includes a second cam protrusion 61 and a second fixation protrusion 62. The second cam protrusion 61 and the second fixation protrusion 62 are aligned in the circumferential direction. The second cam protrusion 61 and the second fixation protrusion 62 are provided as a single member.

The second cam protrusion 61 includes an SP cam surface 17a.

The second fixation protrusion 62 is greater in height than the second cam protrusion 61. In other words, a distal end surface 62a (axially second side end surface) of the second fixation protrusion 62 is located on the second side of a distal end surface 61a of the second cam protrusion 61 in the axial direction. It should be noted that the height of the second fixation protrusion 62 indicates the length thereof in the axial direction.

The radially inner peripheral wall of the second fixation protrusion 62 defines a through hole 62b extending in the axial direction.

The second fixation protrusion 62 is provided with a positioning portion 62c on the outer part thereof. The positioning portion 62c further protrudes than the distal end surface 62a of the second fixation protrusion 62 to the second side in the axial direction.

The support plate 16 further includes the recesses 56. The recesses 56 are each provided to be recessed at a predetermined depth from the axially second side lateral surface of the support plate 16. Each recess 56 is opened in the axial direction. As seen in an axial view, each recess 56 is made in the shape of an oval or rounded rectangular extending in the circumferential direction.

While the distal end surfaces 32a of the first fixation protrusions 32 of the clutch center 13 and the distal end surfaces 62a of the second fixation protrusions 62 of the support plate 16 are in contact with each other, respectively, bolts 53 are inserted through the through holes 62b of the second fixation protrusions 62, respectively, and are further screwed into the screw holes 32b of the first fixation protrusions 32 of the clutch center 13, respectively. Accordingly, the clutch center 13 is fixed to the support plate 16.

The outer peripheral surface of each first fixation protrusion 32 is shaped along the inner peripheral surface of each positioning portion 62c of the support plate 16, and both surfaces are in contact with each other. With the contact of both surfaces, the support plate 16 is radially positioned with respect to the clutch center 13.

### Clutch Plate 15

The clutch plate 15 is disposed between the pressure receiving portion 28 of the clutch center 13 and the pressure applying portion 42 of the pressure plate 14. In other words, the pressure receiving portion 28, the clutch plate 15, and the pressure applying portion 42 are sequentially aligned in this order from the second side to the first side in the axial direction. The clutch plate 15 is opposed to the first slide surface 28a of the clutch center 13. The second slide surface 42a of the pressure plate 14 is opposed to the clutch plate 15.

As shown in FIG. 1, the clutch plate 15 includes a plurality of drive plates 51 and a plurality of driven plates 52. The drive plates 51 and the driven plates 52 are disposed between the pressure receiving portion 28 and the pressure applying portion 42. Transmission of power is allowed or blocked between the clutch outer 12 and both the clutch center 13 and the pressure plate 14 through both types of plates 51 and 52. Both types of plates 51 and 52 are alternately disposed in the axial direction, and each type has an annular shape.

The drive plates 51 are axially movable with respect to the clutch outer 12, while being non-rotatable relative thereto. In other words, the drive plates 51 are unitarily rotated with the clutch outer 12. Specifically, each drive plate 51 is provided with a plurality of engaging protrusions that protrude radially outward from the outer peripheral part thereof. The engaging protrusions are meshed with the cutouts 12c provided for an engagement purpose in the tubular portion 12b of the clutch outer 12. Friction members are attached to both surfaces of each drive plate 51.

The driven plates 52 are composed of a plurality of first driven plates and a single second driven plate. Each of the first and second driven plates includes a plurality of engaging recesses on the inner peripheral end thereof.

The engaging recesses of each first driven plate are engaged with the first teeth 272 provided for an engagement purpose on the tubular portion 27 of the clutch center 13. On the other hand, the engaging recesses provided for an engagement purpose on the second driven plate are engaged with the second teeth 412 of the pressure plate 14. Therefore, each first driven plate is axially movable with respect to the clutch center 13, while being non-rotatable relative thereto. In other words, each first driven plate is unitarily rotated with the clutch center 13. On the other hand, the second driven plate is axially movable with respect to the pressure plate 14, while being non-rotatable relative thereto. In other words, the second driven plate is unitarily rotated with the pressure plate 14.

### Assist Cam Mechanism 17 and Slipper Cam Mechanism 18

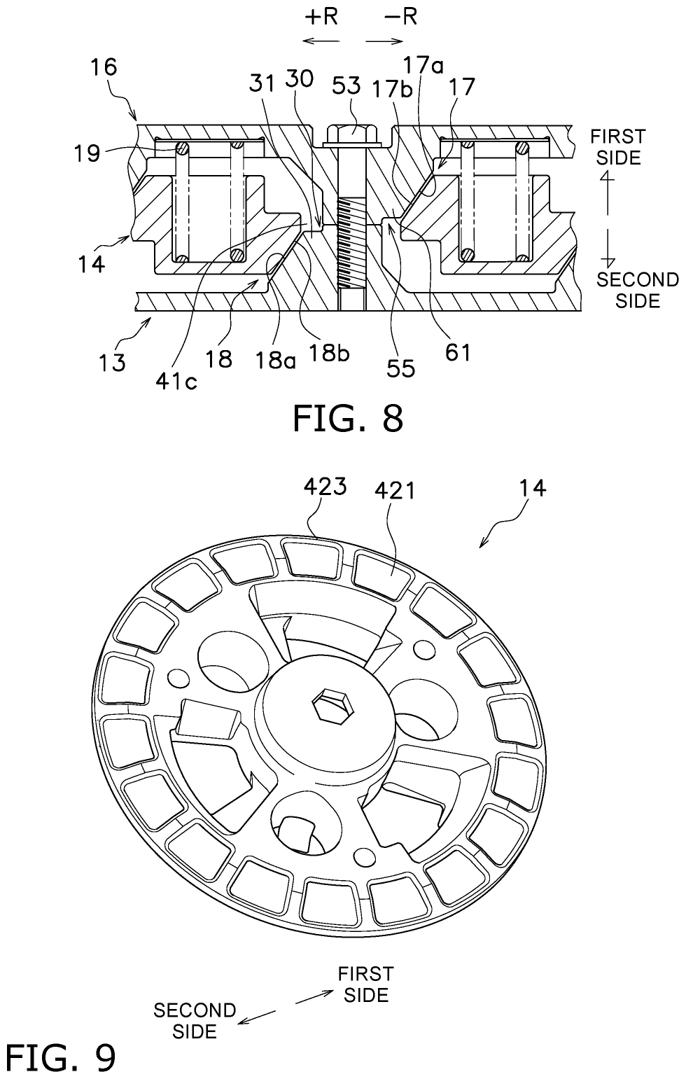

As shown in FIG. 8, the assist cam mechanism 17 is disposed axially between the support plate 16 and the pressure plate 14. The assist cam mechanism 17 is a mechanism for increasing an engaging force of the clutch plate 15 when a forward drive force (positive-side torque, i.e., +R side torque in FIG. 8) acts on the clutch center 13 and the pressure plate 14. On the other hand, the slipper cam mechanism 18 is disposed axially between the pressure plate 14 and the clutch center 13. The slipper cam mechanism 18 is a mechanism for reducing the engaging force of the clutch plate 15 when a reverse drive force (negative-side torque, i.e., −R side torque in FIG. 8) acts on the clutch center 13 and the pressure plate 14.

### <Assist Cam Mechanism 17>

The assist cam mechanism 17 includes a plurality of (herein three) SP cam surfaces 17a provided on the support plate 16 and a plurality of (herein three) PPa cam surfaces 17b provided on the pressure plate 14.

Each SP cam surface 17a is provided on each second cam protrusion 61 of the support plate 16. Each second protruding portion 55 is inserted into each cam hole 41c of the pressure plate 14. Besides, each SP cam surface 17a is provided on one circumferential end surface of each second protruding portion 55.

Each cam hole 41c of the pressure plate 14 is provided with each PPa cam surface 17b. Specifically, each cam hole 41c is provided with each PPa cam surface 17b on one circumferential end surface (wall surface) thereof. Each SP cam surface 17a slants to face the circumferential direction and the second side in the axial direction. Each PPa cam surface 17b slants to face the circumferential direction and the first side in the axial direction. Besides, each SP cam surface 17a is contactable to each PPa cam surface 17b.

### <Slipper Cam Mechanism 18>

The slipper cam mechanism 18 includes a plurality of (herein three) CC cam surfaces 18a provided on the clutch center 13 and a plurality of (herein three) PPs cam surfaces 18b provided on the pressure plate 14.

Each CC cam surface 18a is provided on each first cam protrusion 31 of the clutch center 13. Each first protruding portion 30 is inserted into each cam hole 41c of the pressure plate 14. Besides, each CC cam surface 18a is provided on one circumferential end surface of each first protruding portion 30.

Each cam hole 41c of the pressure plate 14 is provided with each PPs cam surface 18b. Specifically, in each cam hole 41c, a constituent element functioning as each PPs cam surface 18b is an end surface (wall surface) circumferentially disposed in opposition to, and on the opposite side of, the lateral surface (wall surface) that each PPa cam surface 17b is provided. It should be noted that each PPa cam surface 17b and each PPs cam surface 18b are provided to be displaced from each other in the axial direction. Each CC cam surface 18a slants to face the circumferential direction and the first side in the axial direction. Each PPs cam surface 18b slants to face the circumferential direction and the second side in the axial direction. Besides, each CC cam surface 18a is contactable to each PPs cam surface 18b.

### Actions

When a release operation is not being performed in the clutch device 10, the support plate 16 and the pressure plate 14 are urged to directions separating from each other by the coil springs 19. The support plate 16 is fixed to the clutch center 13 and is not moved in the axial direction. Hence, the pressure plate 14 is moved to the second side in the axial direction. As a result, the clutch plate 15 is turned to a clutch-on state.

In this state, a torque outputted from the engine is transmitted to the clutch center 13 and the pressure plate 14 through the clutch plate 15.

Next, actions of the assist cam mechanism 17 and the slipper cam mechanism 18 will be explained in detail.

When a forward drive force acts on the clutch center 13 and the pressure plate 14, in other words, when a positive-side torque acts on the clutch center 13 and the pressure plate 14, a torque herein inputted is outputted to the clutch center 13 and the pressure plate 14 through the clutch plate 15. The torque inputted to the pressure plate 14 is outputted to the support plate 16 through the assist cam mechanism 17. The torque inputted to the support plate 16 is outputted to the clutch center 13 through the respective fixation protrusions 62 and 32. In this way, the torque is transmitted from the pressure plate 14 to the support plate 16, and simultaneously, the assist cam mechanism 17 is actuated.

Specifically, when the forward drive force acts on the clutch center 13 and the pressure plate 14, the pressure plate 14 is rotated relative to the support plate 16. Accordingly, the PPa cam surfaces 17b are pressed against the SP cam surfaces 17a, respectively. The clutch center 13 is not herein moved in the axial direction. Because of this, the support plate 16 is not moved in the axial direction as well. Hence, the PPa cam surfaces 17b are moved along the SP cam surfaces 17a, respectively, whereby the pressure plate 14 is moved to the second side in the axial direction. In other words, the pressure applying portion 42 of the pressure plate 14 is moved toward the pressure receiving portion 28 of the clutch center 13. As a result, the clutch plate 15 is firmly interposed between and held by the pressure applying portion 42 and the pressure receiving portion 28. This increases the clutch engaging force.

On the other hand, when a rider returns a throttle grip to reduce acceleration, a reverse drive force acts on the clutch device 10 through the clutch center 13. In this case, the slipper cam mechanism 18 is actuated. In other words, the clutch center 13 is rotated relative to the pressure plate 14 by a torque transmitted from the transmission side. With this relative rotation, the CC cam surfaces 18a and the PPs cam surfaces 18b are pressed against each other, respectively. The clutch center 13 is not moved in the axial direction. Hence, due to this pressing, the PPs cam surfaces 18b are moved along the CC cam surfaces 18a, respectively, whereby the pressure plate 14 is moved to the first side in the axial direction. As a result, the pressure applying portion 42 is moved in a direction separating from the pressure receiving portion 28. This reduces the clutch engaging force.

When each cam mechanism 17, 18 is actuated as described above, the pressure plate 14 and both the clutch center 13 and the support plate 16 are rotated relative to each other at a predetermined angle. In other words, displacement in rotation-directional phase occurs between the pressure plate 14 and both the clutch center 13 and the support plate 16. Therefore, the coil springs 19 are configured to slip at the end surfaces thereof against the opponent members thereof.

Next, when the rider squeezes a clutch lever, the operating force is transmitted to the release mechanism (not shown in the drawings) through a clutch wire and so forth. The pressure plate 14 is moved by the release mechanism against the urging forces of the coil springs 19 to the first side in the axial direction. When the pressure plate 14 is moved to the first side in the axial direction, the pressing force applied to the clutch plate 15 from the pressure plate 14 is released, and the clutch plate 15 is turned off. In this clutch-off state, a torque is not transmitted to the clutch center 13.

In the clutch device 10, the clutch center 13 includes the plural recesses 21, the ribbed portion 22, and the coupling portion 23. Because of this, the clutch center 13 is reinforced by the coupling portion 23. Hence, the clutch center 13 can be made lightweight by enlarging the recesses 21 without being degraded in strength.

Moreover, in the clutch device 10, the first rotor includes the oil pathways 45. Because of this, the lubricating oil is supplied through the oil pathways 45 to the engaging part between the clutch plate 15 and the first rotor and the surface of the clutch plate 15.

Furthermore, the second regions 24b, not provided with the recesses 21, are herein disposed radially outside the oil pathways 45 at intervals, respectively. In other words, the recesses 21 are not provided near the oil pathways 45. Hence, the first rotor is not herein degraded in strength.

### Other Embodiments

The present invention is not limited to the embodiment described above, and a variety of changes or modifications can be made without departing from the scope of the present invention.

### Modification 1

In the embodiment described above, the plural recesses 21 are provided on the clutch center 13. However, the layout of the plural recesses 21 is not particularly limited to this. The plural recesses 21 may be provided on the pressure plate 14. In this case, the pressure plate 14 corresponds to the first rotor of the present invention, whereas the clutch center 13 corresponds to the second rotor of the present invention.

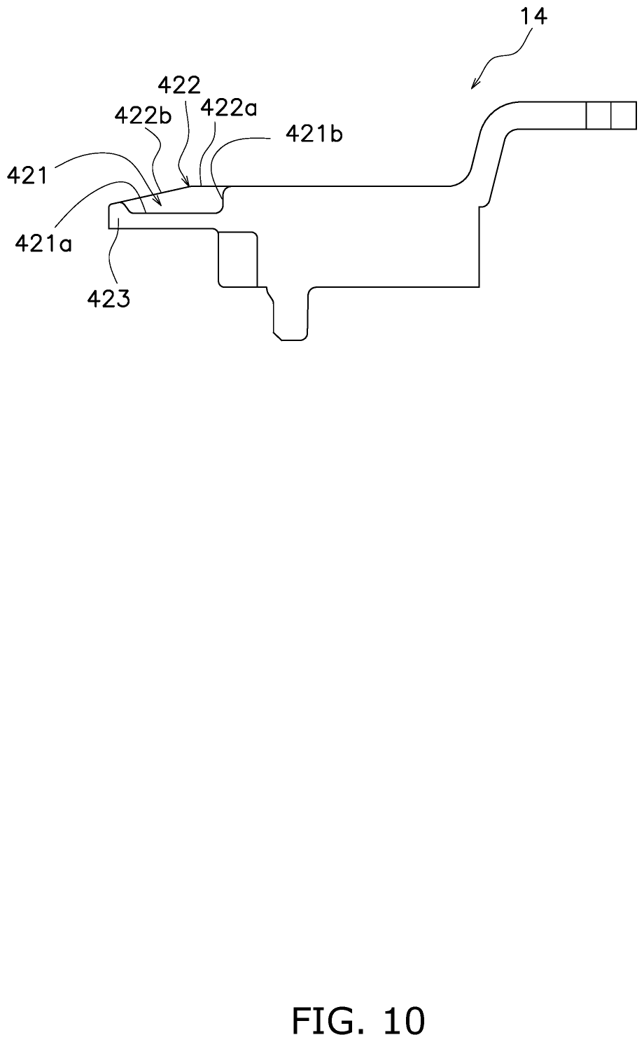

In this case, with reference to FIGS. 9 and 10, the pressure plate 14 includes a plurality of recesses 421, a ribbed portion 422, and a coupling portion 423 on a surface thereof provided axially opposite to the second slide surface 42a.

The plural recesses 421 are aligned in the circumferential direction. Each recess 421 includes a bottom surface portion 421a and a lateral surface portion 421b. The bottom surface portion 421a includes a surface parallel to the second slide surface 42a. In the lateral surface portion 421b, a radially inner part is greater in height than a radially outer part.

The ribbed portion 422 radially extends between each adjacent pair of the recesses 421. Each of ribs in the ribbed portion 422 includes a bottom surface portion 422a parallel to the second slide surface 42a and a lateral surface portion 422b reducing in height from radially inside to radially outside. In this case, each of the ribs in the ribbed portion 422 includes the surface parallel to the second slide surface 42a. Hence, the pressure plate 14 is further enhanced in strength.

The coupling portion 423 is disposed radially outside the recesses 421. The coupling portion 423 circumferentially extends such that each adjacent pair of the ribs in the ribbed portion 422 is coupled therethrough.

### Modification 2

In the embodiment described above, the plural recesses 21 are provided on only either of the clutch center 13 or the pressure plate 14. However, the layout of the plural recesses 21 is not particularly limited to this. The plural recesses 21 may be provided on both the clutch center 13 and the pressure plate 14. In this case, constituent members can be made lightweight as a further advantageous effect.

### Modification 3

The embodiment described above has been explained with the clutch center 13 as an exemplary first rotor and the pressure plate 14 as an exemplary second rotor. In other words, in the embodiment described above, the present invention has been applied to a so-called pull-type clutch device that the pressure plate 14 is moved to the first side in the axial direction so as to tum off the clutch plate 15. However, the present invention is similarly applicable to a so-called push-type clutch device as well.

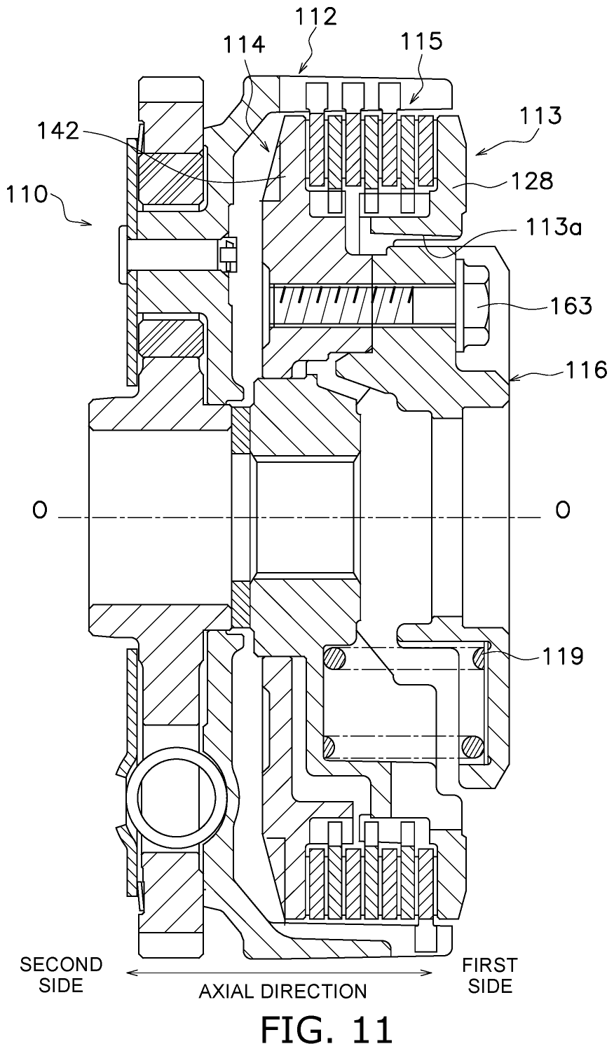

FIG. 11 shows a push-type clutch device.

In a push-type clutch device 110, a pressure plate 114 corresponds to the first rotor; a clutch center 113 corresponds to the second rotor; a support plate 116 corresponds to the support member.

Specifically, in the push-type clutch device 110, the pressure plate 114, the clutch center 113, and the support plate 116 are disposed from the second side to the first side in the axial direction. The pressure plate 114 and the support plate 116 are fixed to each other by at least one bolt 163 through at least one opening 113a provided in the clutch center 113. Besides, at least one coil spring 119 is disposed between the clutch center 113 and the support plate 116. Moreover, a clutch plate 115 is disposed between a pressure applying portion 142 of the pressure plate 114 and a pressure receiving portion 128 of the clutch center 113. These respective members are accommodated in the interior of a clutch outer 112 in a similar manner to those of the pull-type clutch device 10.

The clutch center 113 is not moved in the axial direction. Hence, the support plate 116 is urged by the at least one coil spring 119 to the first side in the axial direction. In other words, the pressure plate 114 fixed to the support plate 116 is urged to the first side in the axial direction and is pressed toward the clutch center 113, whereby the clutch plate 115 is turned on.

Then, the support plate 116 and the pressure plate 114 are moved to the second side in the axial direction against the urging force of the at least one coil spring 119, whereby the clutch plate 115 is turned off.

### Modification 4

The configurations of the clutch center 13 and the pressure plate 14 are not limited to those in the embodiment described above. For example, in the embodiment described above, the disc portion 26, the tubular portion 27, and the pressure receiving portion 28 are integrated in the clutch center 13. However, these portions may be provided as separate members. This configuration may be true of the pressure plate 14, and the boss portion 40, the tubular portion 41, and the pressure applying portion 42 may be provided as separate members.

### Modification 5

In the embodiment described above, the clutch center 13 is provided with the oil pathways 45 penetrating therethrough in the thickness direction thereof. However, the layout of the oil pathways 45 is not particularly limited to this. The oil pathways 45 may be provided in the tubular portion 41 of the pressure plate 14.

### Modification 6

In the embodiment described above, the coil springs are configured to urge the pressure plate 14. However, disc springs or so forth may be used instead of the coil springs.

### REFERENCE SIGNS LIST

10, 110 Clutch device
12, 112 Clutch outer
13, 113 Clutch center (first rotor)
14, 114 Pressure plate (second rotor)
15, 115 Clutch plate
21 Recess
22 Ribbed portion
23 Coupling portion
24 Annular region
24a First region
24b Second region
27 Tubular portion of clutch center (first tubular portion)
28 Pressure receiving portion
28a First slide surface
30 First protruding portion
31 First cam protrusion
41 Tubular portion of pressure plate (second tubular portion)
42 Pressure applying portion
42a Second slide surface
45 Oil pathway

What is claimed is:

1. A clutch device comprising:
a first rotor including a first slide surface;
a second rotor including a second slide surface disposed axially apart from the first slide surface, the second rotor axially movable relative to the first rotor; and
a clutch plate disposed between the first slide surface and the second slide surface, wherein
the first rotor includes an opposite surface axially opposite to the first slide surface, the opposite surface including
a plurality of recesses circumferentially aligned,
a ribbed portion radially extending between each adjacent pair of the plurality of recesses, and
a coupling portion disposed radially outside the plurality of recesses, the coupling portion circumferentially extending such that each adjacent pair of ribs in the ribbed portion is coupled therethrough.

2. The clutch device according to claim 1, wherein
each of the plurality of recesses includes a bottom surface portion and a lateral surface portion, and
the lateral surface portion is greater in height at a radially inner part thereof than at a radially outer part thereof.

3. The clutch device according to claim 1, wherein the ribbed portion reduces in height from radially inside to radially outside.

4. The clutch device according to claim 1, wherein each of the ribs in the ribbed portion includes a surface parallel to the second slide surface and a surface reducing in height from radially inside to radially outside.

5. The clutch device according to claim 1, wherein
the first rotor includes an annular region circumferentially extending on the opposite surface, and
the annular region includes
a first region provided with the plurality of recesses, and
a second region not provided with the plurality of recesses.

6. The clutch device according to claim 5, wherein
the first rotor includes a plurality of oil pathways penetrating therethrough in a thickness direction thereof, the plurality of oil pathways circumferentially aligned, and
the second region is disposed radially outside each of the plurality of oil pathways at an interval.

7. The clutch device according to claim 1, wherein
the first rotor is a clutch center, and
the second rotor is a pressure plate.
